(19) United States
(12) Patent Application Publication
(10) Pub. No.: US 2006/0125400 A1
(43) Pub. Date: Jun. 15, 2006

(54) Green sheet, plasma display panel and method for manufacturing plasma display panel

(75) Inventor: Dae Hyun Park, Gyeonggi-do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/302,425

(22) Filed: Dec. 14, 2005

(30) Foreign Application Priority Data
Dec. 14, 2004 (KR) 10-2004-0105763

(51) Int. Cl. H01J 17/49; H01J 9/24

(52) U.S. Cl. 313/586; 313/587; 445/24

(57) ABSTRACT

A green sheet, a plasma display panel and a method for manufacturing a plasma display panel are disclosed. The plasma display panel is manufactured by using a green sheet comprised of an electrode film comprising nano-conductive particles and a black layer film comprising a sintering material. The green sheet has excellent bonding and sintering characteristics and allows formation of a very small electrode with low resistance, and the plasma display panel and the method for manufacturing a plasma display panel use the green sheet.

This nonprovisional application claims priority under 35 U.S.C. § 119(a) on Patent Application No. 10-2004-105763 filed in Republic of Korea on Dec. 14, 2004 the entire contents of which are hereby incorporated by reference.

### BACKGROUND OF THE INVENTION

1. Field of the Invention

The document relates to a green sheet, a plasma display panel (PDP), and a method for manufacturing a PDP.

2. Description of the Related Art

In general, a PDP comprises a front substrate and a rear substrate each made of soda-lime glass. Barrier ribs formed between the front and rear substrates separate discharge cells. An inert gas such as helium-xenon (He—Xe) or helium-neon (He—Ne) injected into discharge cells generates a discharge by a high frequency voltage. When the discharge occurs, vacuum ultraviolet rays are generated to illuminate phosphor formed between barrier ribs to thereby allow displaying of images.

FIG. 1 shows the structure of a related art PDP. As shown in FIG. 1, the related art PDP comprises a front panel 100 and a rear panel 110. The front panel 100 comprises a front glass substrate 101 and the rear panel 110 comprises a rear glass substrate 111. The front panel 100 and the rear panel 110 are coupled in parallel with a certain distance therebetween.

A pair of sustain electrodes 102 and 103 for sustaining illumination of cells by a mutual discharge are formed on the front glass substrate 101. The pair of sustain electrodes 102 and 103 comprise a scan electrode 102 and a sustain electrode 103. The scan electrode 102 and the sustain electrode 103 comprise transparent electrodes 102-a and 103-a made of a transparent ITO (Indium Tin Oxide) material and bus electrodes 102-b and 103b made of a metal material, respectively. The scan electrode 102 receives a scan signal for scanning and a sustain signal for sustaining a discharge. The sustain electrode 103 mainly receives the sustain signal. An upper dielectric layer 104 is formed at an upper portion of the pair of sustain electrodes 102 and 103, limits a discharge current, and insulates the pair of electrodes. A protection layer 105 is formed on the dielectric layer 104 and made of magnesium oxide (MgO) to promote discharge conditions.

Address electrodes 113 are disposed on the rear glass substrate 111, crossing the pair of sustain electrodes 102 and 103. A lower dielectric layer 115 is formed at an upper portion of the address electrodes 113 and insulates the address electrodes 113. Barrier ribs 112 are formed on the lower dielectric layer 115 and form discharge cells. R, G and B phosphor layer 114 is coated between barrier ribs 112 and emits visible light for displaying images.

The front and rear glass substrates 101 and 111 are attached by a sealing material. After an exhausting process is performed to remove impurities, the inert gas such as He, Ne or Xe is injected into the PDP.

The fabrication process of the PDP comprises a pre-process, a post-process and a module process. The pre-process refers to a process of fabricating the front and rear panels by coating various types of films on the glass substrates through printing, exposing, developing, firing, or the like. The post-process comprises processes of attaching the front and rear panels, exhausting, injecting the discharge gas, tipping off, aging and testing. The module process is a final process for completing the PDP, and can be divided into a circuit mounting process and a set assembling process.

FIG. 2 shows the structure of the front panel of the related art PDP. As shown in FIG. 2, sustain electrodes 11 comprising a transparent electrode 11a made of the ITO material and a bus electrode 11b made of a metal material such as silver (Ag) are formed on a front glass substrate 10.

In general, Ag used for forming the bus electrodes 11b does not transmit light according to a discharge therethrough but reflect an external light. The bus electrode made of Ag degrades the contrast. Thus, in order to prevent degradation of the contrast, a black electrode layer 11c is formed between the transparent electrode 11a and the bus electrode 11b.

A dielectric layer 12 limits a discharge current and covers the sustain electrodes 11 to insulate the sustain electrodes. A protection layer 13 is formed by depositing magnesium oxide (MgO) on the dielectric layer 12 to promote discharge conditions.

A black matrix 14 is arranged between sustain electrodes 11. The black matrix 14 reduces reflection of external light generated from an external source by absorbing it and enhances the purity and contrast of the front substrate 10.

FIGS. 3a to 3g show sequential processes of fabricating the related art PDP.

As shown in FIG. 3a, the transparent electrode 11a made of ITO are formed on the front glass substrate 10, on which black paste 12 is printed through a screen printing method and then dried at a temperature of about 120° C. to form the black electrode layer.

With reference to FIG. 3b, photosensitive Ag paste 13 is printed on the black paste 12 through the screen printing method to form the bus electrodes 11b. The photosensitive Ag paste 13 is then dried at a specific temperature.

As shown in FIG. 3c, some portions of the photosensitive Ag paste 13 are exposed to ultraviolet (UV) rays penetrating through a photo mask (P/M) 30 with a pattern of the bus electrode formed thereon.

With reference to FIG. 3d, other portions of the photosensitive Ag paste 13 which have not been exposed to ultraviolet rays and the black paste 12 are developed by using a developer (developing solution) to form the black electrode layer 11c and the bus electrode 11b. Thereafter, the black electrode layer 11c and the bus electrode 11b are fired for three hours at a temperature of about 550° C.

As shown in FIG. 3e, dielectric paste 14 is printed on the black electrode layer 11c and the bus electrode 11b through the screen printing method. The printed dielectric paste 14 is then dried at a specific temperature.

With reference to FIG. 3f, the black matrix (BM) 15 is printed at a non-discharge area between discharge cells through the screen printing method, and then dried.

As shown in FIG. 3g, the dielectric layer 14 and the black matrix 15 are simultaneously fired for three hours at the temperature of about 550° C. or higher.

With reference to FIGS. 3a to 3g, in the method for manufacturing the related art PDP, the electrodes are formed through the screen printing method. In this respect, however, as the size of the PDP is increasing, a print mask used for the screen printing method must be enlarged accordingly.

The increase in the size of the print mask causes the print mask to be deformed as the number of times of printing increases. Thus, the screen printing method using the print mask is not suitable for the current trend of the PDP with big screens. In addition, with the screen printing method, it is difficult to form a precise electrode pattern, so the screen printing method is not appropriate for fabricating the PDP supporting a full high definition resolution.

Because the screen printing method is not suitable for fabricating the large-scale PDP and cannot form precise electrodes, a green sheet is commonly used to form the electrodes. A related art green sheet comprises a base film, a cover film, an electrode film and a black layer film.

The electrode film of the related art green sheet comprises a glass frit. However, since the glass frit has high resistance, formation of electrodes by using the electrode film comprising the glass frit inevitably causes a problem that resistance of the electrodes increases.

That is, when electrodes are formed by using the electrode film containing the glass frit, resistance of the electrodes would increase, so it would be difficult to form very small (fine) electrodes.

### SUMMARY OF THE INVENTION

Accordingly, an object of the embodiment of the present invention is to solve at least problems and advantages of the background art

One object of the embodiment of the present invention is to provide a green sheet capable of allowing formation of electrodes with low resistance and a plasma display panel (PDP) using the green sheet.

Another object of the embodiment of the present invention is to provide a green sheet capable of allowing formation of a very small electrode and a plasma display panel (PDP) using the green sheet.

To achieve the above objects, there is provided a green sheet for a plasma display panel (PDP) comprising a base film, an electrode film formed on the base film and containing nano-conductive particles, and a cover film formed on the electrode dry film.

To achieve the above objects, there is also provided a method for manufacturing a plasma display panel (PDP) comprising: laminating a green sheet, which is comprised of a black layer film comprising a sintering material and an electrode film formed on the black layer film and comprising nano-conductive particles, on a substrate; exposing the green sheet to light penetrating through a photo mask with an electrode pattern formed thereon; developing the electrode film and the black layer film according to the electrode pattern; and firing an electrode and a black electrode formed according to the development.

To achieve the above objects, there is also provided a plasma display panel (PDP) comprising: a substrate; a black electrode formed on the substrate and comprising a sintering material; and an electrode formed on the black electrode and comprising nano-conductive particles.

The present invention can provide a green sheet having excellent sintering characteristics and bonding characteristics, a plasma display panel (PDP) using the green sheet, and a method for manufacturing a PDP.

The present invention can provide a green sheet capable of allowing formation of an electrode with low resistance, a plasma display panel (PDP) using the green sheet, and a method for manufacturing a PDP.

The present invention can provide a green sheet capable of allowing formation of a very small electrode, a plasma display panel (PDP) using the green sheet, and a method for manufacturing a PDP.

### BRIEF DESCRIPTION OF THE DRAWINGS

An embodiment of the invention will be described in detail with reference to the following drawings in which like numerals refer to like elements

FIG. 1 shows the structure of a plasma display panel (PDP) in accordance with a related art.

FIG. 2 shows the structure of a front panel of the PDP in accordance with the related art.

FIGS. 3a to 3g show sequential processes for fabricating the PDP in accordance with the related art.

FIG. 4 illustrates a green sheet in accordance with the present invention.

FIGS. 5a to 5c show sequential processes for fabricating a PDP using the green sheet in accordance with the present invention.

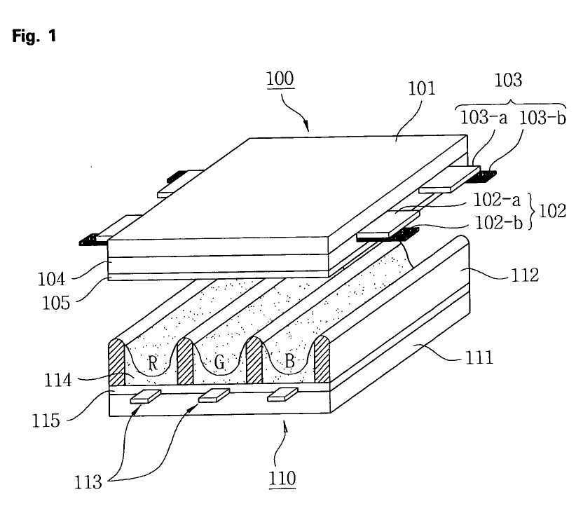

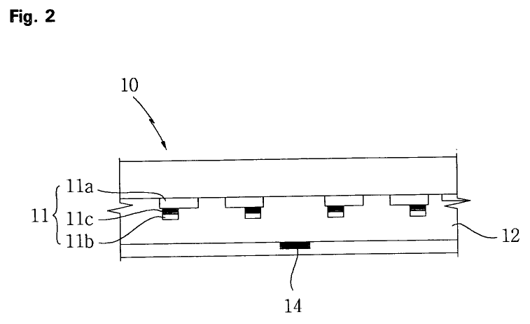

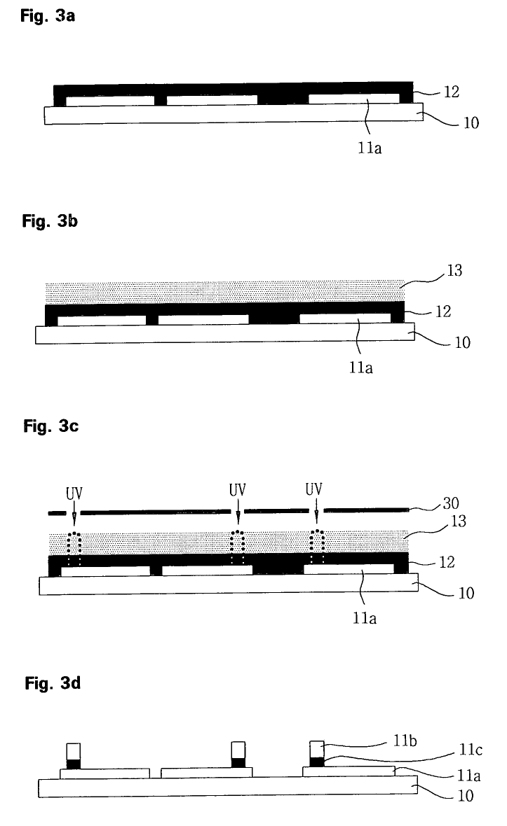

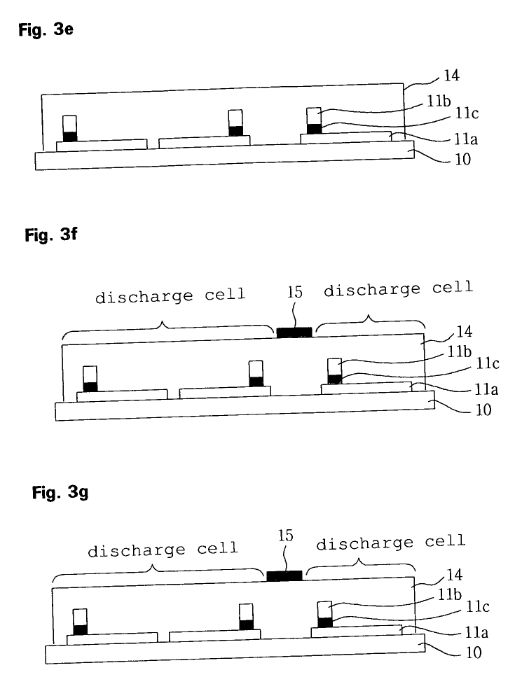

### DETAILED DESCRIPTION OF THE PREFERRED EMBODIMENT

Embodiments of the present invention will be described in a more detailed manner with reference to the drawings.

A green sheet used for a plasma display panel (PDP) in accordance with the present invention comprises a base film, an electrode film formed on the base film and comprising nano-conductive particles, and a cover film formed on the electrode dry film.

The nano-conductive particles are nano Ag particles.

The diameter of the nano-conductive particles is more than or equal to 700 nm to less than or equal to 1,100 nm.

The green sheet further comprises a black layer film formed between the base film and the electrode film and comprising a sintering material.

The sintering material is a glass frit.

The weight percent of the glass frit is more than or equal to 15 wt % to less than or equal to 25 wt % of the black layer film.

The green sheet further comprises a photoresist layer formed between the electrode film and the cover film.

The electrode film comprises a photosensitive material.

A method for manufacturing a plasma display panel (PDP) in accordance with the present invention comprises laminating a green sheet, which is comprised of a black layer film comprising a sintering material and an electrode film formed on the black layer film and comprising nano-conductive particles, on a substrate; exposing the green sheet to light penetrating through a photo mask with an electrode pattern formed thereon; developing the electrode film and the black layer film according to the electrode pattern; and firing an electrode and a black electrode formed according to the development.

The nano-conductive particles are nano Ag particles.

The diameter of the nano-conductive particles is more than or equal to 700 nm to less than or equal to 1,100 nm.

The sintering material is the glass frit.

The weight percent of the glass frit is more than or equal to 15 wt % to less than or equal to 25 wt % of the black layer film.

The electrode film comprises a photosensitive material.

A PDP in accordance with the present invention comprises a substrate, a black electrode formed on the substrate and comprising a sintering material, and an electrode formed on the black electrode and comprising nano-conductive particles.

The sintering material is the glass frit.

The nano-conductive particles are nano Ag particles.

The diameter of the nano-conductive particles is more than or equal to 700 nm to less than or equal to 1,100 nm.

The preferred embodiments of the present invention will now be described with reference to the accompanying drawings.

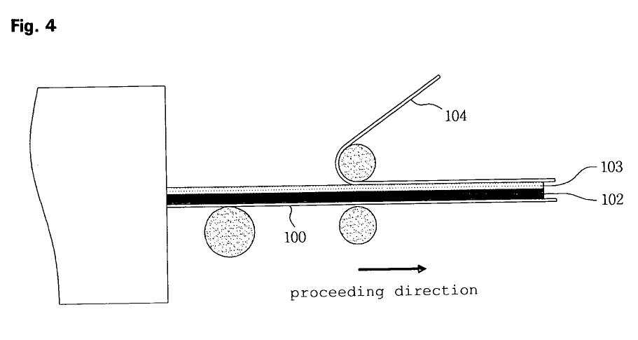

FIG. 4 illustrates a green sheet in accordance with a first embodiment of the present invention. As shown in FIG. 4, the green sheet in accordance with the present invention comprises a base film 100, a black layer film 102, an electrode film 103 and a cover film 104.

The black layer film 102 is used to form a black electrode and formed on the base film 100.

The electrode film 103 is used to form a bus electrode and formed on the black layer film 102.

The cover film 104 is used to protect the black layer film 102 and the electrode film 103 and formed on the electrode film 103.

The green sheet in accordance with the first embodiment of the present invention may additionally comprise a photoresist layer for a photolithography process. Namely, in order to form an electrode through the photolithography process, the photoresist layer can be formed on the electrode film 103. In addition, the black layer film 102 and the electrode film 103 of the green sheet may comprise a photosensitive material for the photolithography process.

The electrode film 103 of the green sheet in accordance with the first embodiment of the present invention comprises nano-conductive particles such as nano Ag particles without having the glass frit. Namely, in the case where the electrode film 103 comprises the nano-conductive particles, since the diameter of the conductive particles is reduced, a firing temperature of the electrode formed with the electrode film 103 can be lowered. Thus, although the electrode film 103 does not contain the glass frit, the sintering characteristics of the electrode film 103 is not degraded.

Since the electrode film 103 in accordance with the first embodiment of the present invention does not contain the glass frit, resistance of the electrode formed with the electrode film 103 is small and thus a very small electrode can be formed with the electrode film 103.

The amount of a glass frit contained in the black layer film 102 of the green sheet is greater than that contained in the black layer film of the related art green sheet. Namely, since the electrode film 103 does not contain the glass frit, bonding characteristics between the electrode formed with the electrode film and the black layer formed with the black layer film may be degraded. Thus, by increasing the amount of the glass frit contained in the black layer film 102, the bonding characteristics between the electrode and the black layer can be enhanced.

The electrode film 103 comprises nano-conductive particles such as Ag, a binder and an organic substance. As for a composition ratio of the electrode film 103, the weight percent of the nano-conductive particles is more than or equal to 50 wt % to less than or equal to 60 wt % and the weight percent of the binder and the organic substance is more than or equal to 30 wt % to less than or equal to 45 wt %. The diameter of Ag particles contained in the related art electrode film is equal to or more than 2 μm to less than or equal to 3 μm. The diameter of the nano-conductive particles such as Ag contained in the electrode film in accordance with the first embodiment of the present invention is more than or equal to 700 nm to less than or equal to 1,100 nm.

The black layer film 102 in accordance with the first embodiment of the present invention comprises a metal oxide, the glass frit, the binder and the organic substance. As for a composition ratio of the black layer film 102, the weight percent of the metal oxide is more than or equal to 10 wt % to less than or equal to 25 wt %, the weight percent of the glass frit is more than or equal to 15 wt % to less than or equal to 25 wt %, and the weight percent of the binder and the organic substance are is less than or equal to 50 wt %. The amount of the glass frit contained in the black layer film 102 in accordance with the first embodiment of the present invention is greater than the amount of the glass frit contained in the related art black layer film. Specifically, the related art black layer film comprises 3 wt %˜10 wt % glass frit, but the black layer film in accordance with the first embodiment of the present invention comprises 15 wt %˜25 wt % glass frit. The diameter of the metal oxide particle of the black layer film 102 is more than or equal to 10 nm to less than or equal to 70 nm, and the diameter of the glass frit particle of the black layer film 102 is more than or equal to 600 nm to less than or equal to 900 nm.

As stated above, since the size of the conductive particles contained in the electrode film 103 is smaller than the size of the conductive particles contained in the related art electrode film and since the amount of the glass frit contained in the black layer film 102 is greater than the amount of the glass frit contained in the related art black layer film, the electrode can be formed with good sintering and bonding characteristics and low resistance. In addition, since the electrode film 103 has the small resistance, it can form a very small electrode.

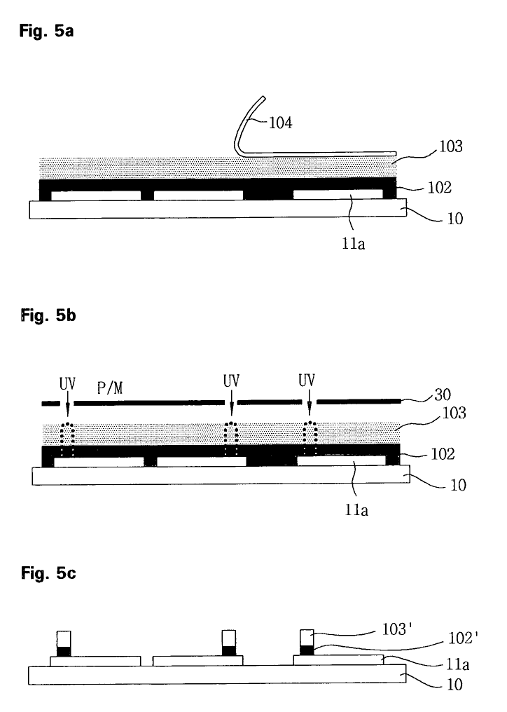

FIGS. 5a to 5c show sequential processes for fabricating a PDP using the green sheet in accordance with a second embodiment of the present invention.

As shown in FIG. 5a, a green sheet, without a base cover (not shown) and a film cover 104 as they have been removed, is laminated on the transparent electrodes 11a made of ITO formed on the front glass substrate 10. Accordingly, the black layer film 102 is formed on the transparent electrodes 11a, on which the electrode film 103 is formed. A composition and a composition ratio of the black layer film 102 are the same as those in the first embodiment of the present invention as described above with reference to FIG. 4, so description of it is thus omitted. Also, a composition, a composition ratio, and a diameter of the conductive particles of the electrode film 103 are the same as those in the first embodiment of the present invention as described above with reference to FIG. 4, so its description is also omitted. The black layer film 102 and the electrode film 103 of the green sheet in accordance with the second embodiment of the present invention comprise a photosensitive material for a photolithography process.

As shown in FIG. 5b, the electrode film 103 is exposed to ultraviolet (UV) rays penetrating through a photo mask 30 with a pattern of a bus electrode formed thereon.

With reference to FIG. 5c, the electrode film 103 and the black layer film 102 are developed by a developer (developing solution). In this case, specifically, some portions of the electrode film 103 which have not been exposed to ultraviolet rays are not developed by the developer while the other portions thereof which have been exposed to ultraviolet rays are developed by the developer. Accordingly, the corresponding portions of the black layer film 102 under the portions of the electrode film 103 which have not been developed are not developed. Meanwhile, the corresponding portions of the black layer film 102 under the developed electrode film 103 are developed by the developer. Accordingly, as shown in FIG. 5c, a black electrode 102′ is formed on the transparent electrode 11a, and a bus electrode 103′ is formed on the black electrode 102′. A firing process is performed thereon at a temperature of 500° C.˜580° C.

When the firing process is performed, since the black layer film 102 in accordance with the second embodiment of the present invention contains more amount of glass frit than that contained in the related art black layer film, the bonding force between the bus electrode 103′ and the black electrode 102′ is strong.

In other words, in this embodiment of the present invention, although the electrode film 103 does not contain the glass frit to reduce resistance, since the black layer film 102 contains the large amount of the glass frit, the bonding force between the bus electrode 103′ and the black electrode 102′ is good.

In addition, because the diameter of the conductive particle contained in the electrode film 103 is smaller than that of the conductive film contained in the related art electrode film, the firing temperature can be lowered. Namely, when the electrode formed with the electrode film 103 in accordance with the second embodiment of the present invention and the electrode formed with the related art electrode film are fired at the same temperature, the electrode formed with the electrode film 103 in accordance with the present invention has superior sintering characteristics to the electrode formed with the related art electrode film. Therefore, although the electrode film 103 in accordance with the present invention does not contain the glass frit, the sintering characteristics of the electrode film 103 is not degraded.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A green sheet for a plasma display panel comprising:
a base film;
an electrode film formed on the base film and comprising nano-conductive particles; and
a cover film formed on the electrode dry film.

2. The green sheet of claim 1, wherein the nano-conductive particles are nano Ag particles.

3. The green sheet of claim 1, wherein the diameter of the nano-conductive particles is more than or equal to 700 nm to less than or equal to 1,100 nm.

4. The green sheet of claim 1, further comprising:
a black layer film formed between the base film and the electrode film and comprising a sintering material.

5. The green sheet of claim 4, wherein the sintering material is a glass frit.

6. The green sheet of claim 5, wherein the weight percent of the glass frit is more than or equal to 15 wt % to less than or equal to 25 wt % of the black layer film.

7. The green sheet of claim 1, further comprising:
a photoresist layer formed between the electrode film and the cover film.

8. The green sheet of claim 1, wherein the electrode film comprises a photosensitive material.

9. A method for manufacturing a plasma display panel comprising:
laminating a green sheet, which comprises a black layer film comprising a sintering material and an electrode film formed on the black layer film and comprising nano-conductive particles, on a substrate;
exposing the green sheet to light penetrating through a photo mask with an electrode pattern formed thereon;
developing the electrode film and the black layer film according to the electrode pattern; and
firing an electrode and a black electrode formed according to the development.

10. The method of claim 9, wherein the nano-conductive particles are nano Ag particles.

11. The method of claim 9, wherein the diameter of the nano-conductive particles is more than or equal to 700 nm to less than or equal to 1,100 nm.

12. The method of claim 9, wherein the sintering material is a glass frit.

13. The method of claim 9, wherein the weight percent of the glass frit is more than or equal to 15 wt % to less than or equal to 25 wt % of the black layer film.

14. The method of claim 9, wherein the electrode film comprises a photosensitive material.

15. A plasma display panel comprising:
a substrate;
a black electrode formed on the substrate and comprising a sintering material; and
an electrode formed on the black electrode and comprising nano-conductive particles.

16. The panel of claim 15, wherein the sintering material is a glass frit.

17. The panel of claim 15, wherein the nano-conductive particles are nano Ag particles.

18. The panel of claim 15, wherein the diameter of the nano-conductive particles is more than or equal to 700 nm to less than or equal to 1,100 nm.
